(19) United States
(12) Patent Application Publication
(10) Pub. No.: US 2018/0312241 A1
(43) Pub. Date: Nov. 1, 2018

(54) LANDING GEAR FAIRING WITH AERODYNAMIC SURFACES FOR TAIL SITTER AIRCRAFT

(71) Applicant: Sikorsky Aircraft Corporation, Stratford, CT (US)

(72) Inventor: Mark R. Alber, Milford, CT (US)

(73) Assignee: Sikorsky Aircraft Corporation, Stratford, CT (US)

(21) Appl. No.: 15/568,950

(22) PCT Filed: Apr. 25, 2016
(86) PCT No.: PCT/US2016/029128

§ 371 Date: Oct. 24, 2017

Related U.S. Application Data
(60) Provisional application No. 62/152,317, filed on Apr. 24, 2015.

(51) Int. Cl. B64C 7/00; B64C 29/02; B64C 25/10; B64C 25/36; B64D 29/02

(52) U.S. Cl. CPC B64C 7/00; B64C 29/02; B64D 29/02; B64C 25/36; B64C 25/10

(57) ABSTRACT

A fairing for a landing gear wheel assembly on a tail sitter aircraft is disclosed, which includes a fairing housing defining a longitudinal axis, and at least one pair of laterally opposed aerodynamic tail surfaces extending radially outward from the fairing housing for added flight stability.

### CROSS REFERENCE TO RELATED APPLICATIONS

This application claims priority to and the benefit of U.S. Provisional Application No. 62/152,317, filed Apr. 24, 2015, entitled LANDING GEAR FAIRING WITH AERODYNAMIC SURFACES FOR TAIL SITTER AIRCRAFT, which is incorporated by reference herein in its entirety.

### BACKGROUND OF THE INVENTION

### 1. Field of the Invention

The subject invention is directed to aircraft landing gear, and more particularly, to a landing gear fairing with integral aerodynamic surfaces for improving the stability of a tail sitter aircraft in a forward flight mode.

### 2. Description of Related Art

In a winged tail sitter type vertical takeoff and landing (VTOL) aircraft, the fuselage is horizontal for normal flight and vertical for hovering or alighting, takeoff and landing. The same propulsion system is used for forward flight and for hover, and can either be a ducted fan or an external propeller or rotor.

The stability and longitudinal center of gravity range of a rotor blown winged tail sitting aircraft in the forward flight mode can be challenging. Typically, the wing shape is tailored to meet stringent performance criteria. The body of the aircraft uses control surfaces that interact with the internal and/or external air flow to produce control moments that control the body attitude during flight.

The landing gear of a tail sitter aircraft typically extends rearwardly in an aft direction from the tail section of the aircraft to support the fuselage in a vertical position. Tail sitting aircraft typically have four relatively simple landing gears, of which two or more are a castor type wheel. Castor type wheels are free to turn about an axis perpendicular to the wheel axle. This freedom to turn allows the aircraft to move along the ground while pointed vertically. In some instances, the castor wheels are provided with a fairing to reduce the drag of the landing gear when the aircraft is in a forward flight mode.

It would be beneficial to provide a landing gear fairing that can improve the longitudinal center of gravity range and stability of a winged tail sitter aircraft while it is operating in the forward flight mode.

### SUMMARY OF THE INVENTION

The subject invention is directed to a new and useful aerodynamic fairing for use in conjunction with the landing gear wheel assemblies of a tail sitter aircraft to improve the flight stability and longitudinal center of gravity range of the aircraft.

The aerodynamic structure includes a fairing housing defining a longitudinal axis for covering at least a portion of a wheel assembly. The fairing housing is designed for streamlining and reducing in flight drag associated with the wheel assembly. At least one pair of laterally opposed aerodynamic tail surfaces extend radially outward from the fairing housing for added flight stability.

In an embodiment of the invention, each aerodynamic tail surface is formed integral with the fairing housing. It is envisioned however, that the aerodynamic tail surfaces could be formed as separate components that are fastened to the fairing housing to form an integral assembly. Preferably, each of the tail surfaces has a rearward swept leading edge and a forward swept trailing edge. However, these aerodynamic features could vary by design and have different platform shapes, such as, for example, a rectangular shape.

It is envisioned that the fairing housing could include two pairs of laterally opposed aerodynamic tail surfaces, wherein one pair of aerodynamic tail surfaces would extend in a horizontal plane and the oilier pair of aerodynamic tail surfaces would extend in a vertical plane.

The subject invention is also directed to a landing gear assembly for a tail sitter aircraft that includes a gear housing defining a longitudinal axis, a piston coaxially arranged with respect to the gear housing, a wheel assembly supported on an aft end of the piston, a fairing covering at least a portion of the wheel assembly and defining a longitudinal axis aligned with the axis of the gear housing, and at least one pair of laterally opposed aerodynamic tail surfaces that extend radially outwardly from the fairing for added flight stability.

Preferably, the piston is mounted for axial movement relative to the gear housing between an extended position corresponding to a generally horizontal flight condition and a retracted position corresponding to a generally vertical take-off condition. It is envisioned that the axial movement of the piston relative to the gear housing could be controllable during flight to selectively adjust the position of the laterally opposed aerodynamic tail surfaces, thereby providing a mechanism for more precisely controlling in flight stability.

In one embodiment of the invention, the fairing and the wheel assembly are mounted for movement in tandem about the longitudinal axis of the fairing. In another embodiment, the wheel assembly is mounted for rotation relative to the fairing about the axis of the fairing. In either instance, the moveable wheel assembly provides the mobility of a nose gear assembly to enable the aircraft to be steered while taxing, as opposed to the fixed axial position of a main gear assembly.

The subject invention is also directed to a tail sitter aircraft, which includes an elongated fuselage defining a longitudinal fuselage axis, a pair of laterally opposed horizontal main wings extending radially outwardly from the fuselage, a nacelle supported on each main wing defining a longitudinal nacelle axis extending parallel to the longitudinal axis of the fuselage, and a pair of laterally opposed vertical tail wings extending radially outwardly from each nacelle, a gear housing supported on each tail wing and defining a longitudinal housing axis extending parallel to the nacelle axis, a piston coaxially arranged with respect to each gear housing, a wheel assembly supported on an aft end of each piston, a fairing covering a portion of each wheel assembly, and at least one pair of laterally opposed aerodynamic tail surfaces extending outwardly from at least one of the fairings for added flight stability.

In one embodiment of the aircraft, each of the four fairings includes the aerodynamic tail surfaces. In another embodiment, at least two of the four fairings include aerodynamic tail surfaces. In the latter case, it is envisioned that the two fairings that include the aerodynamic tail surfaces could either be set above the main wings when the aircraft is in a horizontal flight mode, or below the main wings when the aircraft is in a horizontal flight mode. The selected configuration would be based upon the design criteria of the particular aircraft.

These and other features of the subject invention and the manner in which it is manufactured and employed will become more readily apparent to those having ordinary skill in the art from the following enabling description of the preferred embodiments of the subject invention taken in conjunction with the several drawings described below.

### BRIEF DESCRIPTION OF THE DRAWINGS

So that those skilled in the art to which the subject invention appertains will readily understand how to make and use the subject invention without undue experimentation, preferred embodiments thereof will be described in detail herein below with reference to certain figures, wherein:

FIG. 1 is a top plan view of the tail sitter aircraft of the subject invention with the axis of the fuselage extending in a horizontal orientation, corresponding to forward flight mode, and wherein the laterally opposed aerodynamic tail surfaces associated with the landing gear wheel fairings are shown;

FIG. 2 is a front elevational view of the tail sitter aircraft shown in FIG. 1, showing the laterally opposed aerodynamic tail surfaces associated with each of the tour landing gears;

FIG. 3 is a side elevational view of the tail sitter aircraft shown in FIG. 1;

FIG. 4 is an enlarged localized view of the landing gear assembly of the subject invention in an extended position, wherein aerodynamic tail surfaces provide added aerodynamic benefit to the aircraft;

FIG. 5 is an enlarged localized view of the landing gear assembly of the subject invention in a retracted position, corresponding to a vertical take-off and landing mode;

FIG. 6 is a perspective view of a landing gear assembly that includes a wheel fairing having four aerodynamic tail surfaces;

FIG. 7 is a front elevational view of a tail sitter aircraft wherein opposed aerodynamic tail surfaces are associated with the wheel fairings located above the main wing of the aircraft when the aircraft is in a horizontal flight mode; and

FIG. 8 is a front elevational view of a tail sitter aircraft wherein opposed aerodynamic tail surfaces are associated with the wheel fairings located below the main wing of the aircraft when the aircraft is in a horizontal flight mode.

### DETAILED DESCRIPTION OF PREFERRED EMBODIMENTS

Referring now to the drawings, wherein like reference numerals identify similar structural features or aspects of the subject invention, there is illustrated in FIG. 1 a rotor blown wing tail sitter aircraft designated generally by reference numeral 10. The tail sitter aircraft 10 includes an elongated fuselage 12 defining a longitudinal fuselage axis X_{f}. As illustrated in FIGS. 1 through 3, the fuselage 12 of the aircraft 10 is in a horizontal orientation corresponding to a forward flight mode.

Referring to FIG. 1, a pair of laterally opposed horizontal main wings 14a and 14b extends radially outwardly from the fuselage 12, perpendicular to the fuselage axis X_{f}. Nacelles 16a and 16b are supported on main wings 14a and 14b, respectively. Each nacelle 16a, 16b defines a longitudinal nacelle axis Xₙ, extending parallel to the longitudinal axis X_{f} of fuselage 12. The nacelles 16a and 16b have respective propellers or rotors 15a and 15b operatively associated therewith.

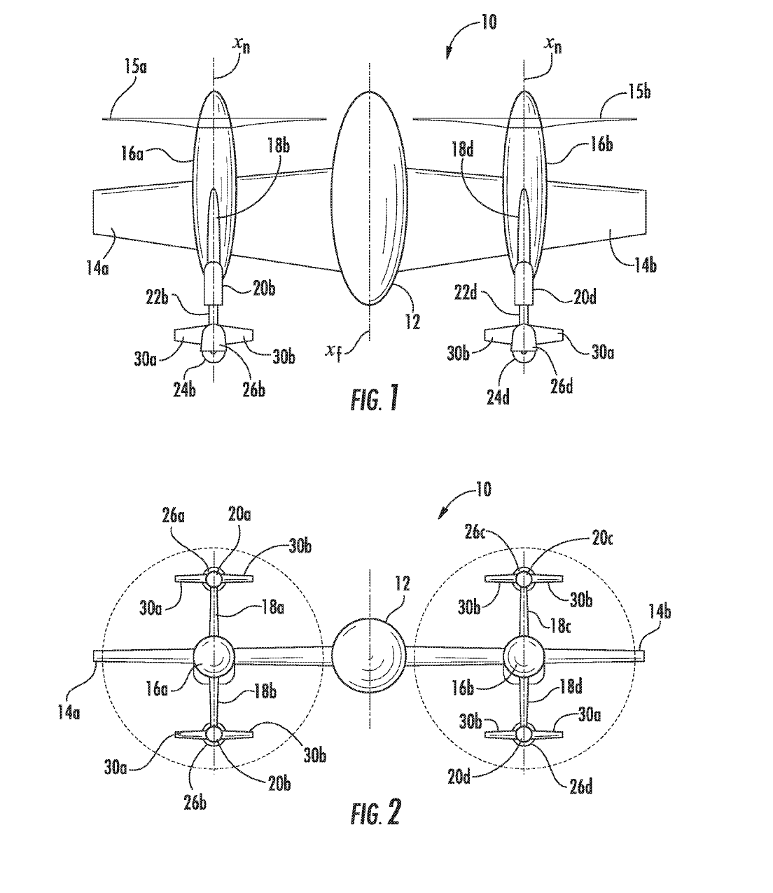

Referring to FIG. 2, a pair of laterally opposed vertical tail wings 18a and 18b extends radially outwardly from nacelle 16a. When the aircraft 10 is in horizontal flight mode as shown, tail wing 18a extends above main wing 14a, while tail wing 18b extends below main wing 14a. A pair of laterally opposed vertical tail wings 18c and 18d extends radially outwardly from nacelle 16b. When the aircraft 10 is in the illustrated horizontal flight mode, tail wing 18c extends above main wing 14b and tail wing 18d extends below main wing 14b.

Referring to FIGS. 1 through 3, landing gear housings 20a-20d are supported on vertical tail wings 18a-18d, respectively. The four landing gear housings 20a-20d each define a longitudinal housing axis Xₕ extending parallel to the associated nacelle axis Xₙ. Landing gear housings 20a-20d include respective coaxially arranged pistons 22a-22d and associated wheel assemblies 24a-24d, which are supported on the aft end of pistons 22a-22d, respectively. The wheel assemblies 24a-24d are preferably constructed with two or more castor-type assemblies, so that these wheels are free to turn about the housing axis Xₕ. This freedom to turn allows the aircraft 10 to move along the ground while it is pointed vertically.

With continuing reference to FIGS. 1 through 3, generally cylindrical fairings 26a-26d cover a portion of each wheel assembly 24a-24d, respectively. The fairings 26a-26d are designed for streamlining and reducing drag associated with the wheel assemblies 24a-24d during horizontal flight. Each fairing 26a-26d includes a pair of tail surfaces for added stability during horizontal flight. More particularly, each fairing 26a-26c1 includes an inboard radially extending aerodynamic tail surface 30a and an outboard radially extending aerodynamic tail surface 30b.

In one embodiment of the invention, the aerodynamic tail surfaces 30a, 30b are formed integral with each of the fairings 26a-26d. It is envisioned however, that the aerodynamic tail surfaces 30a, 30b could be formed as separate components that are fastened to each of the fairings 26a-26d to form an integral assembly. Preferably, each of tail surfaces 30a, 30b has a rearward swept leading edge 32 and a forward swept trailing edge 34. However, these aerodynamic features could vary by design. Moreover, the tail surfaces 30a, 30b could have a variety of different platform shapes, such as, for example, rectangular or elliptical. The tail surfaces 30a, 30b could also be delta-wing shaped, or the leading and/or trailing surfaces could be curved, depending upon the design criteria for the aircraft. The aerodynamic tail surfaces 30a, 30b are preferably sized to remain within the lateral load of the landing gear, minimizing weight.

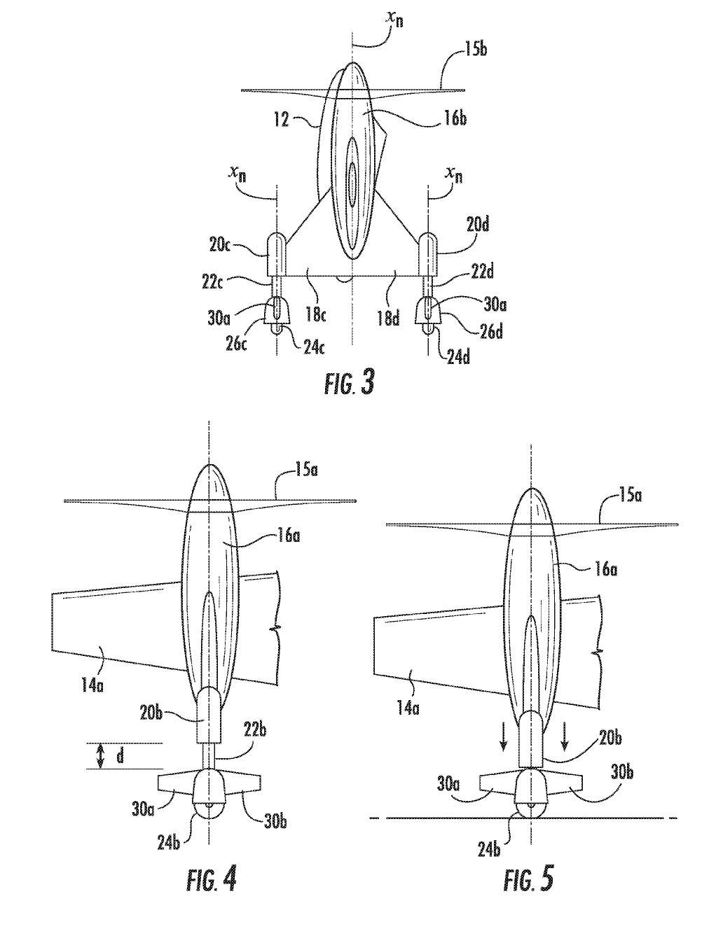

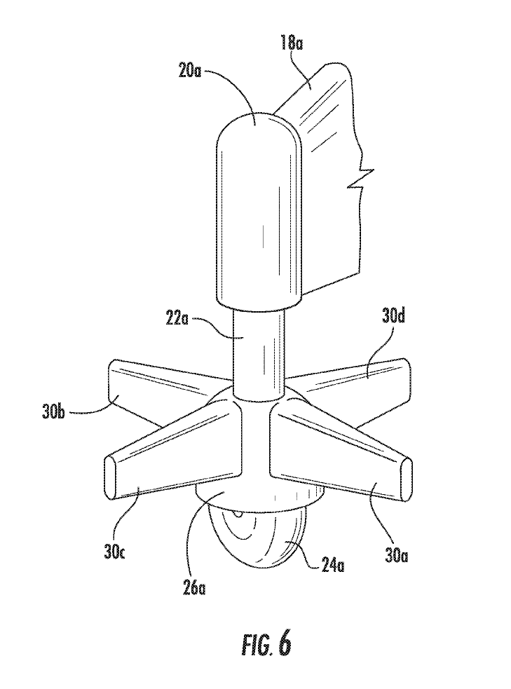

Referring now to FIGS. 4 and 5, the pistons 22a-22d are mounted for axial movement relative associated landing gear housing 20a-20d between the extended position of FIG. 4, corresponding to a horizontal flight condition, and the retracted (or compressed) position of FIG. 5, corresponding to a vertical take-off or lauding condition. This maintains the ground clearance of the added aerodynamic surfaces while the aircraft 10 is alighting or descending and eliminates the need for any additional landing gear retraction mechanism.

Furthermore, when the pistons 22a-22d are in the extended in-flight position of FIG. 4, the moment arms thereby created (increased by a distance “d” relative to the retracted position of FIG. 5) and the resulting forces associated with the aerodynamic tail surfaces 30a, 30b will be greater. This provides added stability for the aircraft 10 during flight. This also improves the longitudinal center of gravity range of the aircraft 10, providing a further benefit to in flight control.

It is envisioned that the axial movement of the pistons 22a-22d relative to the landing gear housings 20a-20d could be controllable during flight, to selectively adjust the position of the laterally opposed aerodynamic tail surfaces 30a, 30b associated with each fairing 26a-26d. This would provide a mechanism for more precisely controlling in flight stability. Moreover, it is envisioned that pistons 22a-22d could be selectively adjusted in tandem or individually during flight, further enhancing the ability to control the aircraft.

Referring to FIG. 6, it is envisioned that one or more of the fairings 26a-26d could include four radially outward extending aerodynamic tail surfaces 30a-30d. In such an instance, one pair of aerodynamic tail surfaces 30a and 30b would extend in a horizontal plane, as previously described, and the other pair of aerodynamic tail surfaces 30c and 30d would extend in a vertical plane.

In an embodiment of the invention, the fairings 26a-26d and the associated wheel assemblies 24a-24d are mounted for movement in tandem about the longitudinal axis of the fairings. In another embodiment, the wheel assemblies 24a-24d are mounted for rotation relative to the fairings 26a-26d about the axis of the fairing. In either instance, the moveable wheel assemblies 24a-24d provide the mobility of a nose gear assembly to enable the aircraft 10 to be steered over the ground while taxing in a vertical orientation, as opposed to the fixed axial position of a main gear assembly.

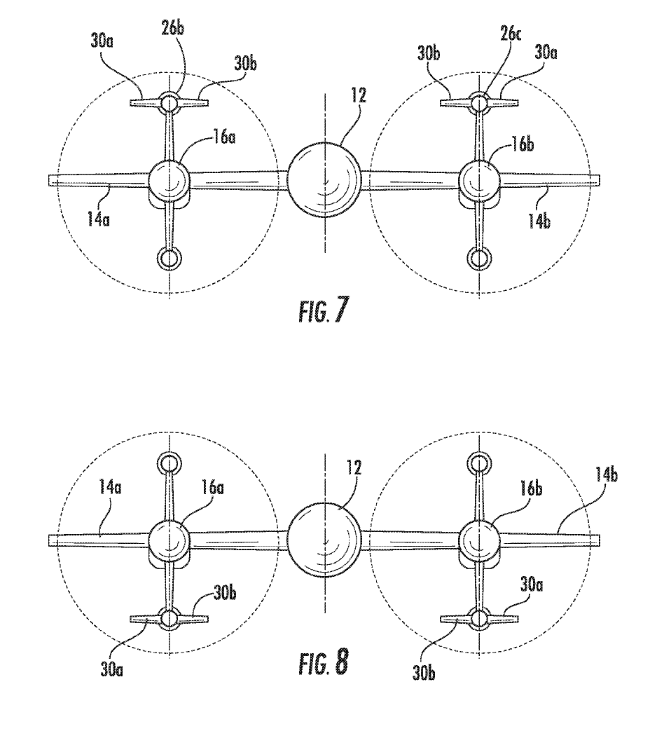

In the embodiment of the aircraft shown in FIGS. 1 through 3, each of the fairings 26a-26d includes the aerodynamic tail surfaces 30a, 30h. In other embodiments, it is envisioned that at least two of the fairings 26a-26d may include aerodynamic tail surfaces 30a, 30b. For example, it is envisioned that the two fairings 26a and 26e that are set above the main wings 14a, 14b when the aircraft 10 is in a horizontal flight mode would include the aerodynamic tail surfaces 30a, 30b, as shown in FIG. 7.

Alternatively, the two fairings 26b and 26d that are set below the main wings 14a and 14b when the aircraft 10 is in a horizontal flight mode would include the aerodynamic tail surfaces 30a, 30b, as shown in FIG. 8. It is also envisioned that only one of the fairings would include the aerodynamic tail surfaces 30a, 30b. The selected configuration would be based upon the design criteria of the particular aircraft.

While the subject invention has been shown and described with reference to preferred embodiments, those skilled in the art will readily appreciate that various changes and/or modifications may be made thereto without departing from the spirit and scope of the subject invention as defined by the appended claims.

What is claimed is:

1. A landing gear fairing for a tail sitter aircraft, comprising:
a) a fairing housing defining a longitudinal axis for covering at least a portion of a wheel assembly; and
b) at least one pair of laterally opposed aerodynamic tail surfaces extending radially outward from the fairing housing for added flight stability.

2. A landing gear fairing as recited in claim 1, wherein each aerodynamic tail surface has a rearward swept leading edge.

3. A landing gear fairing as recited in claim 1, wherein each aerodynamic tail surface has a forward swept trailing edge.

4. A landing gear fairing as recited in claim 1, wherein the fairing housing includes two pairs of laterally opposed aerodynamic tail surfaces.

5. A landing gear fairing as recited in claim 1, wherein the laterally opposed aerodynamic tail surfaces are formed integral with the fairing housing.

6. A landing gear assembly for a tail sitter aircraft, comprising:
a) a gear housing defining a longitudinal axis;
b) a piston coaxially arranged with respect to the gear housing;
c) a wheel assembly supported on an aft end of the piston;
d) a fairing covering at least a portion of the wheel assembly and defining a longitudinal axis aligned with the axis of the gear housing; and
e) at least one pair of laterally opposed aerodynamic tail surfaces extending radially outwardly from the fairing for added flight stability.

7. A landing gear assembly as recited in claim 6, wherein the piston is mounted for axial movement relative to the gear housing between an extended position corresponding to a generally horizontal flight condition and a retracted position corresponding to a generally vertical take-off condition.

8. A landing gear assembly as recited in claim 7, wherein the axial movement of the piston relative to the gear housing is controllable during flight to adjust the position of the laterally opposed aerodynamic tail surfaces.

9. A landing gear assembly as recited in claim 6, wherein the fairing and the wheel assembly are mounted for movement in tandem about the longitudinal axis of the fairing.

10. A landing gear assembly as recited in claim 6, wherein the wheel assembly is mounted for rotation relative to the fairing about the axis of the fairing.

11. A landing gear assembly as recited in claim 6, wherein each tail surface has a rearward swept leading edge and the a forward swept trailing edge.

12. A tail sitter aircraft, comprising:
a) an elongated fuselage defining a longitudinal fuselage axis;
b) a pair of laterally opposed horizontal main wings extending radially outwardly from the fuselage;
c) a nacelle supported on each main wing defining a longitudinal nacelle axis extending parallel to the longitudinal axis of the fuselage;
d) a pair of laterally opposed vertical tail wings extending radially outwardly from each nacelle;
c) a gear housing supported on each tail wing and defining a longitudinal housing axis extending parallel to the nacelle axis;
f) a piston coaxially arranged with respect to each gear housing;
g) a wheel assembly supported on an aft end of each piston;
h) a fairing covering a portion of each wheel assembly; and
i) at least one pair of laterally opposed aerodynamic tail surfaces extending outwardly from at least one of the fairings for added flight stability.

13. A tail sitter aircraft as recited in claim 12, wherein each piston is mounted for axial movement relative to a respective gear housing between an extended position corresponding to a generally horizontal flight condition and a retracted position corresponding to a generally vertical take-off condition.

14. A tail sitter aircraft as recited in claim 13, wherein the axial movement of each piston relative to the gear housing associated therewith is controllable during flight to adjust the position of the laterally opposed aerodynamic tail surfaces associated therewith.

15. A tail sitter aircraft as recited in claim 12, wherein at least one fairing and the wheel assembly associated therewith are mounted for movement in tandem about the longitudinal axis of that fairing.

16. A tail sitter aircraft as recited in claim 12, wherein at least one wheel assembly is mounted for rotation relative to the fairing associated therewith about the longitudinal axis of that fairing.

17. A tail sitter aircraft as recited in claim 12, wherein each of the fairings includes aerodynamic tail surfaces.

18. A tail sitter aircraft as recited in claim 12, wherein at least two of the fairings include aerodynamic tail surfaces.

19. A tail sitter aircraft as recited in claim 18, wherein the two fairings that include aerodynamic tail surfaces are set above the main wings when the aircraft is in horizontal flight.

20. A tail sitter aircraft as recited in claim 18, wherein the two fairings that include aerodynamic tail surfaces are set below the main wings when the aircraft is in horizontal flight.
